(19) United States
(12) Patent Application Publication
(10) Pub. No.: US 2023/0111240 A1
(43) Pub. Date: Apr. 13, 2023

(54) CONE NOZZLE

(71) Applicant: Lechler GmbH, Metzingen (DE)

(72) Inventors: Daniela HOLDER, Beuren (DE); Sebastian ROHACZ, Metzingen (DE)

(21) Appl. No.: 17/932,858

(22) Filed: Sep. 16, 2022

(30) Foreign Application Priority Data
Oct. 8, 2021 (DE) 102021211378.8

(51) Int. Cl. B05B 1/34

(52) U.S. Cl. CPC B05B 1/3426

(57) ABSTRACT

A cone nozzle having a housing, with a liquid inlet, a swirl chamber, a feed channel extending from the liquid inlet and opening into the swirl chamber, and an outlet channel having an outlet opening. The outlet channel starts from the swirl chamber, and, directly upstream of the opening into the swirl chamber, the feed channel is aligned tangentially with respect to an imaginary circular line around the central longitudinal axis of the swirl chamber. The liquid inlet is arranged parallel to the central longitudinal axis of the swirl chamber, and the feed channel has at least two deflections through an angle of between 80° and 100°, each between the liquid inlet and the opening into the swirl chamber.

### CROSS-REFERENCE TO RELATED APPLICATION

This claims priority from German Application No. 10 2021 211 378.8, filed Oct. 8, 2021, the disclosure of which is hereby incorporated by reference in its entirety.

### TECHNICAL FIELD

The invention relates to a cone nozzle having a housing, wherein the housing has a liquid inlet, a swirl chamber, a feed channel extending from the liquid inlet and opening into the swirl chamber, and an outlet channel having an outlet opening, wherein the outlet channel starts from the swirl chamber, and wherein, directly upstream of the opening into the swirl chamber, the feed channel is aligned tangentially with respect to an imaginary circular line around the central longitudinal axis of the swirl chamber.

### BACKGROUND AND SUMMARY

Cone nozzles having a swirl chamber into which the liquid to be sprayed is introduced tangentially with respect to an imaginary circular line around the central longitudinal axis of the swirl chamber are also referred to as tangential nozzles. However, it is often advantageous for reasons of installation space to introduce the liquid into the housing of a nozzle axially with respect to the emerging spray cone.

The invention is intended to improve a cone nozzle that has tangential inflow to the swirl chamber.

According to the invention, a cone nozzle having the following features is provided for this purpose.

In the case of a cone nozzle having a housing, wherein the housing has a liquid inlet, a swirl chamber, a feed channel extending from the liquid inlet and opening into the swirl chamber, and an outlet channel having an outlet opening, wherein the outlet channel starts from the swirl chamber, wherein, directly upstream of the opening into the swirl chamber, the feed channel is aligned tangentially with respect to an imaginary circular line around the central longitudinal axis of the swirl chamber, it is envisaged that the liquid inlet is arranged parallel to the central longitudinal axis of the swirl chamber, and that the feed channel has at least two deflections through an angle of between 80° and 100° each between the liquid inlet and the opening into the swirl chamber.

As a result, the inflow to the cone nozzle according to the invention can be axial and the housing can be fastened to the end of a feed line for the liquid to be sprayed, and the emerging spray jet then has a central longitudinal axis which is parallel to the central longitudinal axis of the feed line or coincides with the central longitudinal axis of the feed line. By virtue of the fact that, between the liquid inlet and the opening into the swirl chamber, the feed channel has at least two deflections at an angle of in each case between 80° and 100°, it is surprisingly achieved that, on the one hand, the cone nozzle according to the invention has large free cross sections and that, on the other hand, it nevertheless has a comparatively small volume flow. The two deflections are deliberately designed to be at right angles or approximately at right angles in order to dissipate flow energy of the liquid to be sprayed which is carried through. This has the effect that, despite large free cross sections, only a small volume flow flows through the deflections. Together with the tangential inflow to the swirl chamber, it is thereby possible to produce conical spray jets with coarse droplets and only a small volume flow. The invention is based on the recognition that the deliberate production of energy dissipation or the deliberately inefficient design of the two deflections between the entry of the liquid to be sprayed into the housing and the opening into the swirl chamber is extremely advantageous if coarse droplets are to be achieved with a low volume flow and large free cross sections. As a result, the cone nozzle according to the invention is particularly insensitive to clogging and, in addition, can produce spray jets with a coarse droplet spectrum at a relatively small volume flow.

As a further development of the invention, two rectilinear sections of the feed channel meet at at least one of the deflections of the feed channel.

In this way, while being easy to produce, it is possible to achieve a right-angled or virtually right-angled deflection which is deliberately designed to be inefficient and has a high flow resistance.

As a further development of the invention, the feed channel has a cross section which is constant with the exception of the deflections, wherein the cross section in the region of the deflections is greater than or equal to the cross section outside the region of the deflections.

In this way, the feed channel can be designed with large free flow cross sections, and nevertheless sufficient flow energy is dissipated in the region of the deflections to achieve a coarse droplet spectrum in the spray jet which is discharged.

As a further development of the invention, the feed channel has three rectilinear sections each having a constant cross section, wherein a first rectilinear section is arranged between the liquid inlet and the first deflection, a second rectilinear section is arranged between the first deflection and the second deflection and a third rectilinear section is arranged between the second deflection and the opening of the feed channel into the swirl chamber.

In this way, two right-angled or virtually right-angled deflections can be formed in a device which is easy to manufacture.

As a further development of the invention, the feed channel has a circular cross section with the exception of the deflections.

In this way, the feed channel can be produced by drilling into solid material, for example.

As a further development of the invention, the nozzle housing is of at least two-part design, wherein a first housing part has at least one section of the liquid inlet and one part of the feed channel, and a second housing part has the swirl chamber, the outlet channel and a further part of the feed channel.

The fact that there are two housing parts which are mounted one on top of the other makes the feed channel easy to produce. The housing parts can be fixed in the intended position relative to one another by means of locating pins, for example, and can then be pressed against one another. Welding of the two housing parts is likewise possible. Sections of the feed channel can be drilled from a lateral surface of the housing parts or of the housing and then closed by means of plugs or caps. This applies, for example, to a rectilinear section between the liquid inlet and the first deflection and a rectilinear section between the second deflection and the opening into the swirl chamber. A third rectilinear section between the two deflections can then be formed by means of blind holes in the surfaces of the housing parts which are mounted one on top of the other, or by means of grooves which, in the assembled state, are covered by means of a further housing part.

As a development of the invention, the swirl chamber is closed by means of a cover at its end opposite the outlet channel. A cover of this kind can be screwed or pressed in, for example. A cover can also be formed integrally on a first housing part, which is mounted on a second housing part, in which the swirl chamber is located. A cover of this kind can be provided with projections on its surface facing the swirl chamber in order to influence a flow in the swirl chamber. These projections can be designed, for example, in the form of a prism with a triangular base surface and can be arranged concentrically around a central longitudinal axis of the swirl chamber. In other words, the projections are then designed in the manner of pieces of cake and are arranged at a distance from one another on the outer circumference of the cover of the swirl chamber.

As a development of the invention, the first housing part and the second housing part are accommodated, at least partially, in a bore of a third housing part.

In this way, the two housing parts can be secured to one another and, for example, a union nut is screwed onto the third housing part and then fixes the first housing part and the second housing part in the third housing part.

As a further development of the invention, the first housing part has a circumferential collar, wherein the collar defines a recess in which the second housing part is partially accommodated.

In this way, the first housing part and the second housing part can be exactly and correctly positioned in the radial direction and can be mounted on one another in a liquid-tight manner by the second housing part being pushed in a very simple manner into the recess formed by the collar on the first housing part. Sections of the feed channel can thus be provided in the two housing parts, and boundaries of the feed channel can then be formed both by the first housing part and by the second housing part. As a result, the feed channel can be formed, for example, by means of a groove on the first housing part and/or on the second housing part and is not completely formed until the two housing parts are placed on one another. After the second housing part has been pushed into the recess which defines the circumferential collar of the first housing part, the two housing parts can be secured to one another at the end of the collar and simultaneously sealed off by means of a circumferential weld seam. A correct position in the circumferential direction of the second housing part in the recess of the first housing part can be ensured by means of a locating pin which engages, on the one hand, in a blind hole in the first housing part and, on the other hand, in a blind hole in the second housing part.

Further features and advantages of the invention will be found in the claims and the following description of preferred embodiments of the invention in conjunction with the drawings. Individual features of the different embodiments which are illustrated and described can be combined with one another in any desired manner without exceeding the scope of the invention. This also applies to the combination of individual features without further individual features together with which they are illustrated and/or described.

### BRIEF DESCRIPTION OF THE DRAWINGS

FIG. 1 shows a perspective illustration of a cone nozzle according to the invention in accordance with a first embodiment obliquely from below;

FIG. 2 shows a sectional view of the cone nozzle of FIG. 1;

FIG. 3 shows a further sectional view of the cone nozzle of FIG. 1 obliquely from below;

FIG. 4 shows the first housing part of the cone nozzle of FIG. 1 obliquely from below;

FIG. 5 shows the second housing part of the cone nozzle of FIG. 1 obliquely from above;

FIG. 6 shows a partially sectioned, perspective view obliquely from below of a cone nozzle according to the invention in accordance with a second embodiment;

FIG. 7 shows a side view of the cone nozzle of FIG. 6;

FIG. 8 shows a sectional view of the cone nozzle of FIG. 6;

FIG. 9 shows a view of the sectioned area C-C in FIG. 8;

FIG. 10 shows an enlarged illustration of the detail D from FIG. 8;

FIG. 11 shows a sectional view of the cone nozzle of FIG. 6 obliquely from below;

FIG. 12 shows the first housing part of the cone nozzle of FIG. 6 obliquely from below;

FIG. 13 shows the second housing part of the cone nozzle of FIG. 6 obliquely from above;

FIG. 14 shows a perspective illustration of a cone nozzle according to the invention in accordance with a third embodiment obliquely from below;

FIG. 15 shows a side view of the cone nozzle of FIG. 14;

FIG. 16 shows a sectional view of the cone nozzle of FIG. 14; and

FIG. 17 shows a sectional view of the cone nozzle of FIG. 14, the position of the plane E-E being apparent from FIG. 16.

### DETAILED DESCRIPTION

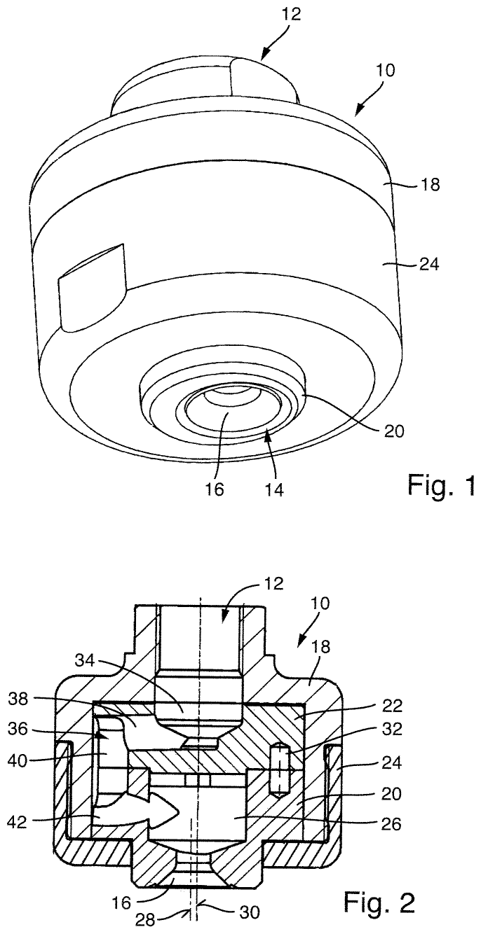

FIG. 1 shows a cone nozzle 10 according to the invention having a liquid inlet 12 and an outlet opening 14. The outlet opening 14 is situated at the end of a widening outlet channel 16. The cone nozzle 10 has a housing which has a third housing part 18, a second housing part 20, a first housing part 22, which cannot be seen in FIG. 1, and a union nut 24. The liquid inlet 12 is attached to the third housing part 18 and the union nut 24 is screwed onto an external thread, which cannot be seen in FIG. 1, of the third housing part 18. The third housing part 18 has a bore, in which the first housing part 22 and the second housing part 20 are accommodated, see also FIG. 2. The first housing part 22 and the second housing part 20 are held in the bore of the third housing part 18 by means of the union nut 24.

It can be seen in FIG. 1 that the outlet opening 14 and the outlet channel 16 are not arranged concentrically with the housing and with the swirl chamber of the cone nozzle 10. Within the scope of the invention, the outlet opening and the outlet channel may also be arranged concentrically with the swirl chamber and/or with the housing.

As can be seen in FIG. 2, although the outlet channel 16 and the outlet opening 14 are of rotationally symmetrical design, a central longitudinal axis of the outlet channel 16 and of the outlet opening 14 are arranged offset with respect to a swirl chamber 26 of the cone nozzle 10. However, a central longitudinal axis 28 of the outlet channel 16 and a central longitudinal axis 30 of the swirl chamber 26 are parallel to one another. In FIG. 2, it can also be seen that the central longitudinal axis 30 of the swirl chamber 26 coincides with a central longitudinal axis of the third housing part 18.

FIG. 2 shows the sectional view of the bore in the third housing part 18, in which the first housing part 22 and the second housing part 20 are accommodated. A relative position of the first housing part 22 and of the second housing part 20 is secured by means of a locating pin 32, which is arranged, on the one hand, in a blind hole in a surface of the first housing part 22 which faces the second housing part and, on the other hand, is arranged in a blind hole in a surface of the second housing part 20 which faces the first housing part 22.

Starting from the liquid inlet 12 in the third housing part 18, the liquid to be sprayed flows into an inlet chamber 34 of the first housing part 22 and then into a feed channel 36, which opens into the swirl chamber 26. The feed channel 36 has a first rectilinear section 38, a second rectilinear section 40 and a third rectilinear section 42. The first rectilinear section 38 has a circular cross section and leads from the inlet chamber 34 to a first deflection between the first rectilinear section 38 and the second rectilinear section 40. The first deflection has an angle of slightly less than 90°.

The second rectilinear section 40 leads from the first deflection to a second deflection between the second rectilinear section 40 and the third rectilinear section 42. The second deflection is embodied with an angle of 90°. The third rectilinear section 42 opens into the swirl chamber 26.

The first rectilinear section 38 has a circular cross section. The second rectilinear section 36 has an irregular cross section since a side wall of the second rectilinear section is formed by a section of the inner circumference of the bore or groove in the third housing part 18. The third rectilinear section 42 again has a circular cross section. FIG. 2 shows the intersection between the swirl chamber 26, which is circular in cross section, and the third rectilinear section 42, which is circular in cross section.

The feed channel 36 thus leads from the inlet chamber 34 to the swirl chamber 26 and has two deflections in the region of 90°. A further, approximately right-angled, deflection takes place between the liquid inlet 12 or inlet chamber 34 and the first rectilinear section 38 of the feed channel 36. Within the scope of the invention, the deflections can each have an angle of between 80° and 100°. It can be seen from FIG. 2 that the deflections of the feed channel 36 are formed by intersections of the rectilinear sections 38, 40 and 42, respectively. The first and the second deflection in the feed channel 36 are thus deliberately not designed to be favourable in terms of flow. As a result, flow energy of the liquid to be sprayed flowing through the housing of the cone nozzle 10 is dissipated. As a result, a spray jet with coarse droplets can be produced by means of the swirl chamber 26 and the outlet channel 16, and nevertheless a lower volume flow is output through the cone nozzle 10 than if the first deflection and the second deflection were, for example, rounded and designed with a radius of curvature.

According to the invention, the two deflections in the feed channel 36 are thus deliberately designed to be inefficient in order to produce a flow resistance. As a result, the free cross sections of the sections 38, 40, 42 of the feed channel 36 can be designed to be comparatively large, making the cone nozzle 10 insensitive to clogging. Nevertheless, owing to the comparatively high flow resistance of the two deflections in the feed channel 36, a volume flow entering the swirl chamber 26 is kept low. This makes it possible to produce a spray jet having a coarse droplet spectrum with a comparatively low volume flow.

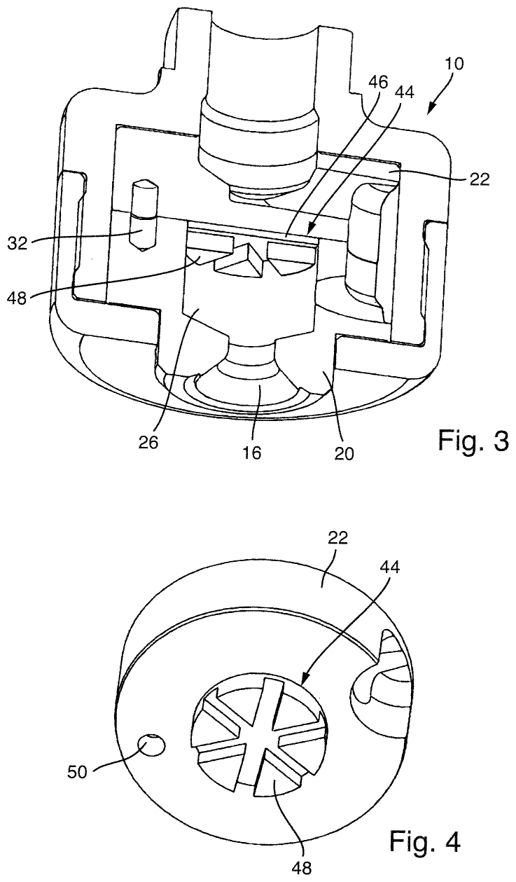

FIG. 3 shows a sectional view of the cone nozzle 10 of FIGS. 1 and 2 obliquely from below. In this view, it can be seen that the first housing part 22 closes the swirl chamber 26 in the second housing part 20 and, for this purpose, has a projection 44 which projects into the swirl chamber 26. A cover for the swirl chamber 26 is therefore integrated into the first housing part 22. The projection 44 has a first section 46, which is of circular disk-shaped design and the outside diameter of which corresponds to the inside diameter of the swirl chamber 26 or is only slightly smaller. The disk-shaped projection 46 thereby ensures correct positioning of the first housing part 22 on the second housing part 20 in the radial direction and, in addition, also closes the swirl chamber 26 on the side opposite the outlet channel 16. Correct positioning of the first housing part 22 on the second housing part 20 in the circumferential direction is ensured by means of the locating pin 32.

There is a total of six prismatic projections 48 on the circular disk-shaped projection 46, of which only three can be seen in FIG. 3. The prismatic projections 48 each have the shape of a circular sector and their respective tips point towards the central longitudinal axis of the swirl chamber 26. In other words, the prismatic projections 48 each have the shape of a piece of cake and are oriented with their tip towards the central longitudinal axis of the swirl chamber 26. There is in each case a spacing between the side surfaces of the prismatic projections 48, and the spacing between two prismatic projections 48 is always the same. The prismatic projections 48 influence the flow in the swirl chamber 26 and ensure uniform liquid distribution in the discharged conical spray jet. Within the scope of the invention, it is also possible for the prismatic projections 48 to have some other shape in order to achieve a different distribution of liquid in the discharged conical spray jet. Within the scope of the invention, the prismatic projections 48 can also be omitted and the side of the swirl chamber 26 opposite the outlet channel can be of smooth design or, for example, can also be provided with only one concentric projection projecting into the swirl chamber.

FIG. 4 shows the first housing part 22 in a view from below. In this view, the blind hole 50 for the locating pin 32 is visible, and all six prismatic projections 48 are visible on the projection 44.

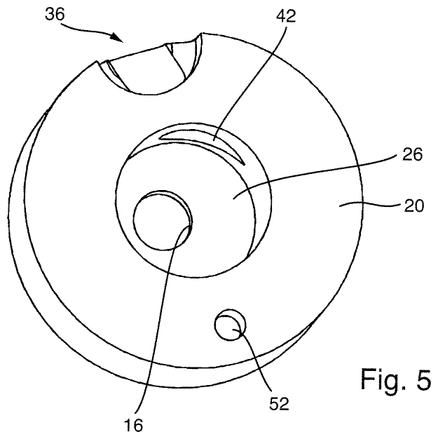

FIG. 5 shows the second housing part 20 in a view from above. The blind hole 52 for the locating pin 32 can be seen on the second housing part 20. The opening of the third rectilinear section 42 of the feed channel 36 into the swirl chamber 26 as well as a section of the outlet channel 16 can also be seen. As has been explained, the outlet channel 16 is not arranged concentrically with the swirl chamber 26, which is circular in cross section.

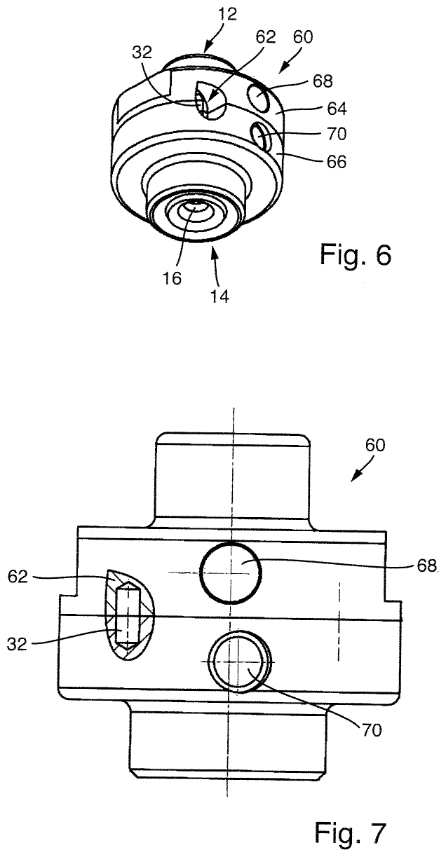

FIG. 6 shows a cone nozzle 60 according to the invention in accordance with a second embodiment of the invention obliquely from below, the cone nozzle 60 being cut open in a region 62. As a result, a locating pin 32 can be seen in the region 62, see also FIG. 7, which pin aligns a first housing part 64 and a second housing part 66 of the cone nozzle 60 with respect to one another.

The first housing part 64 has a liquid inlet 12. The second housing part 66 has an outlet opening 14 at the end of an outlet channel 16.

In the view according to FIG. 6, it is possible to see a first cover 68 and a second cover 70, which are fitted into bores in the first housing part 64 and in the second housing part 66, respectively, and which, as will be explained below, close off a feed channel for the liquid to be sprayed from the environment. The two housing parts 64, 66 are placed leak-tightly one on top of the other and are, for example, welded together. A weld seam can then run around the outer circumference of the two housing parts 64, 66. Such a weld seam then holds the two housing parts 64, 66 against one another and also seals off the feed channel in the interior of the housing of the cone nozzle 60.

FIG. 7 shows a partially sectioned side view of the cone nozzle 60. It is possible to see the two covers 68, 70, which close the feed channel with respect to the environment.

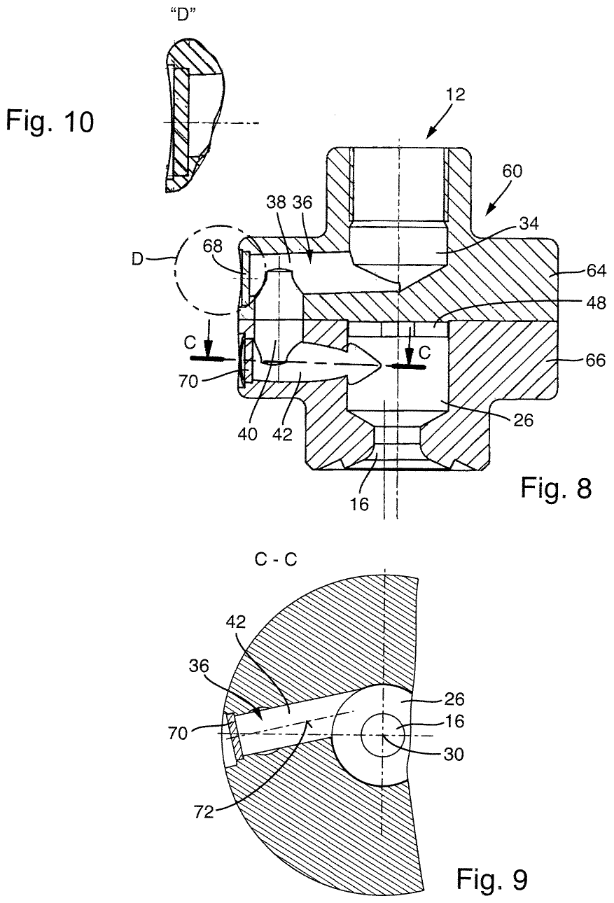

FIG. 8 shows a sectional view of the cone nozzle 60. The feed channel 36 extends between an inlet chamber 34 in the first housing part 64 and a swirl chamber 26 in the second housing part 66. The feed channel 36 has three rectilinear sections 38, 40, 42 and two deflections through an angle of approximately 90° in each case.

The liquid is deflected for the first time by slightly less than 90° between the liquid inlet 12 and the first rectilinear section 38. There is a deflection by an angle of somewhat more than 90°, for example 92°, between the first rectilinear section 36 and the second rectilinear section 40. There is a further deflection by an angle of 90° between the second rectilinear section 40 and the third rectilinear section 42. The third rectilinear section 42 opens into the swirl chamber 26.

As has already been explained with reference to the cone nozzle 10 of FIGS. 1 to 5, the deflections ensure a reduction in the flow energy of the liquid to be sprayed and, as a result, a comparatively low volume flow with large free cross sections and, in conjunction with the swirl chamber 26, a coarse droplet spectrum of the discharged conical spray jet.

It can be seen in FIG. 8 that the first rectilinear section 36 can be drilled from an outer circumference of the first housing part 64. The bore is then closed by means of the cover 68, which is, for example, welded or soldered in.

The second rectilinear section 40 is formed by two mutually aligned blind holes. A first blind hole is drilled into the first housing part 64 and the second blind hole is drilled into the second housing part 66. When the two housing parts 64, 66 are in contact with one another as shown in FIG. 8, the two blind holes are aligned and form the second rectilinear section 40 of the feed channel 36.

The third rectilinear section 42 can be drilled from an outer circumference of the second housing part 66. The cover 70 then closes off the third rectilinear section 42 from the environment and is likewise welded or soldered in.

Arranged at an end of the swirl chamber 26 opposite the outlet channel 16 is a total of six prismatic projections 48, which project a short distance into the swirl chamber 26. The shape and arrangement of the prismatic projections 48 correspond to the already explained arrangement of the prismatic projections 48 of the cone nozzle 10 of FIGS. 1 to 5.

FIG. 9 shows a view of the sectioned area C-C in FIG. 8. It can be seen in this view that the feed channel 36 opens tangentially into the swirl chamber 26 with its third rectilinear section 42. It can be seen in particular that a central longitudinal axis 72 of the third rectilinear section 42 of the feed channel 36 is arranged tangentially with respect to an imaginary circular line around a central longitudinal axis 30 of the swirl chamber 26.

It can also be seen from FIG. 9 that, in the case of the cone nozzle 60, the outlet channel 16 is arranged concentrically with the swirl chamber 26.

Within the scope of the invention, the cone nozzle according to the invention can, for example, also be produced integrally by means of 3D printing.

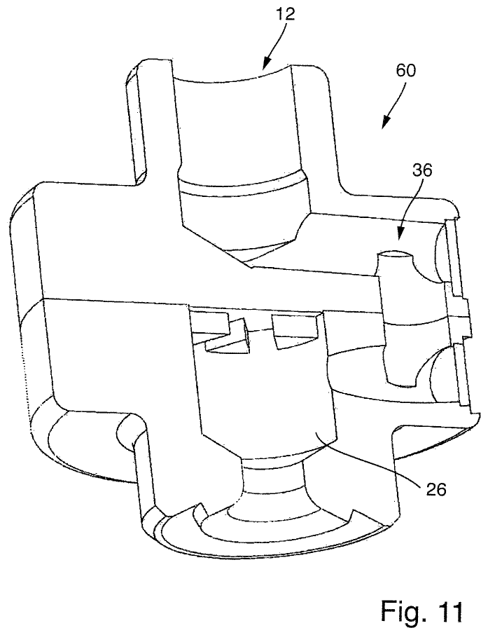

FIG. 11 shows a sectional view of the cone nozzle 60 of FIG. 6. In this view, a total of three approximately right-angled or right-angled deflections of the feed channel 36 between the liquid inlet 12 and the opening into the swirl chamber 26 can be clearly seen. It can also be seen that these deflections are deliberately not rounded or designed in a manner favourable to flow, but instead are embodied by the meeting of rectangular bores. As a result, the feed channel 36 is deliberately designed to be inefficient and forms a flow resistance. Surprisingly, this has considerable advantages with regard to large free flow cross sections and, as a result, insensitivity to clogging of the feed channel 36, with regard to a coarse droplet spectrum of the discharged conical spray jet and with regard to a low volume flow which is output by the conical spray jet produced.

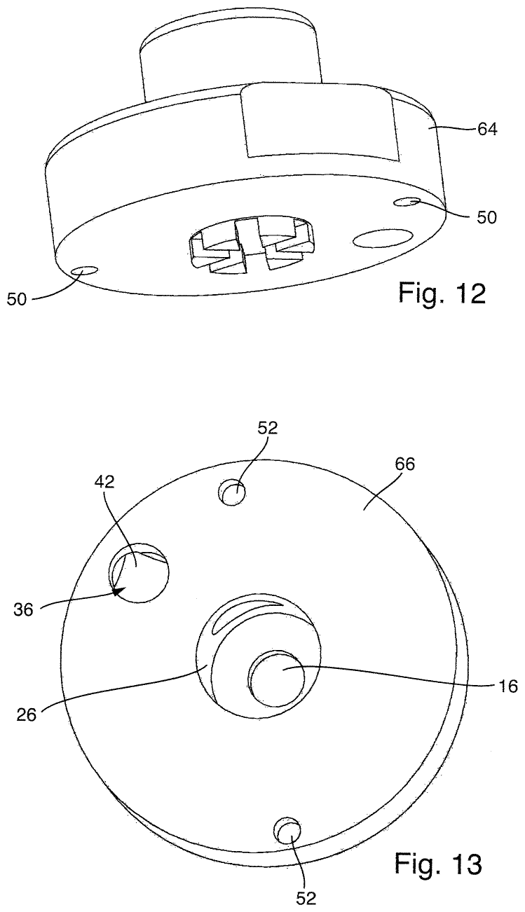

FIG. 12 shows the first housing part 64 in a view obliquely from below. In this view, it can be seen that the first housing part 64 has two blind holes 50 for receiving dowel pins.

FIG. 13 shows the second housing part 66 of the cone nozzle 66 in a view obliquely from above. It is possible to see two blind holes 52 for locating pins 32, a section of the outlet channel 16, the swirl chamber 26 and the opening of the third rectilinear section 42 of the feed channel 36 into the swirl chamber 26.

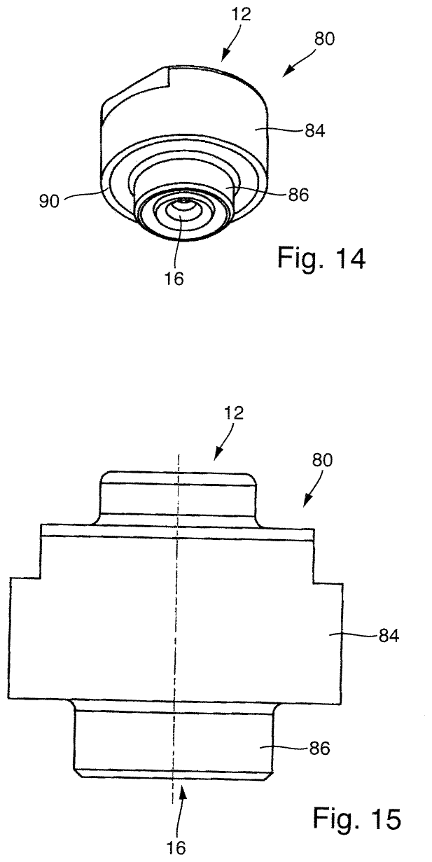

FIG. 14 shows a cone nozzle 80 according to the invention in accordance with a third embodiment. The cone nozzle 80 has a first housing part 84 and a second housing part 86, wherein the second housing part 86 is pushed partially into the first housing part 84, and the two housing parts 84, 86 are then secured to one another by means of a circumferential weld seam 90.

FIG. 14 shows an outlet channel 16 of the cone nozzle 80. A liquid inlet 12 is hidden in FIG. 14. The function of the cone nozzle 80 is very similar to that of cone nozzles 10 and 60 already described, and therefore the path of the liquid to be sprayed through the cone nozzle 80 and the generation of a conical spray jet is not described again.

FIG. 15 shows a side view of the cone nozzle 80. Engagement surfaces for an open-ended wrench are provided on the side of the first housing part 84 in order to screw the cone nozzle 80 onto the external thread of a feed pipe or a spray lance, for example.

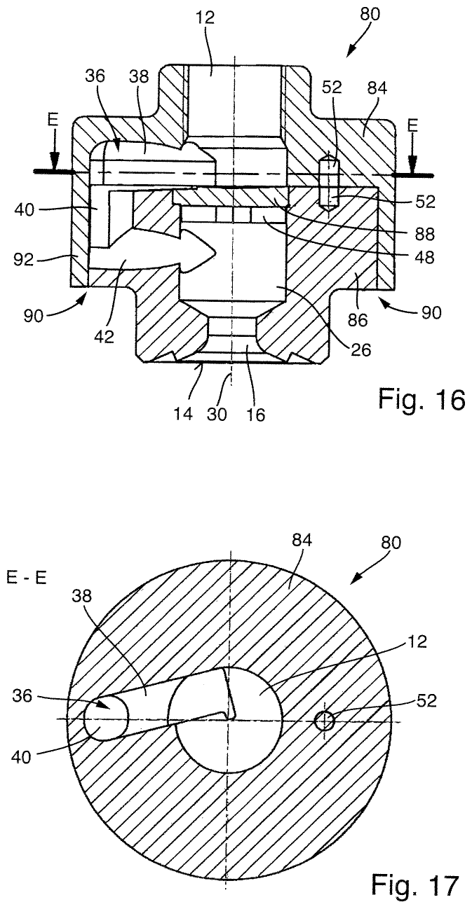

FIG. 16 shows a sectional view of the cone nozzle 80. As already explained, the cone nozzle 80 is very similar in functional terms to the cone nozzles 10, 60 already explained. Liquid to be sprayed enters through a liquid inlet 12 and is then passed from the liquid inlet 12 into a feed channel 36. From the liquid inlet 12 to a first rectilinear section 38 of the feed channel 36, the liquid is deflected by approximately 90°. A further deflection by 90° takes place between the first rectilinear section 38 and a second rectilinear section 40 of the feed channel 36. Proceeding from the second rectilinear section 40, the liquid is then deflected once more by approximately 90° and then enters the third rectilinear section 42 of the feed channel 36. The third rectilinear section 42 of the feed channel 36 opens into the swirl chamber 26. The third rectilinear section 42 opens tangentially into the swirl chamber 26, see also FIG. 17, with the result that, as the liquid to be sprayed enters the swirl chamber, rotation is imparted to it about a central longitudinal axis of the swirl chamber 26.

The liquid then emerges from the swirl chamber 26 via the outlet channel 16, at the end of which the outlet opening 14 is arranged. The liquid emerges from the outlet channel 16 in the form of a conical spray jet.

An end of the swirl chamber 26 opposite the outlet channel 16 is closed by a cover 88. The cover 88 can be pressed into the second housing part 86. Arranged on a side of the cover 88 facing the swirl chamber 26 is a plurality of prismatic projections 48, the arrangement and function of which has already been explained with reference to the cone nozzles 10, 60.

The two housing parts 84, 86 each have recesses 52 in the form of a blind hole. In the correctly installed state of the two housing parts 84, 86, the recesses 52 come to lie opposite one another. A locating pin can then be inserted into the recesses 52 in order to hold the first housing part 84 and the second housing part 86 in a correct rotational position relative to one another.

The first housing part 84 has a circumferential collar 90, the inner circumference of which is matched to the outer circumference of the second housing part 86. As a result, the circumferential collar 90 forms a circular-disk-shaped recess, into which a section of the second housing part 86 can be pushed.

In the correctly aligned position of the second housing part 86 relative to the first housing part 84 shown in FIG. 16, the boundaries of the feed channel 36 are formed partly by the first housing part 84 and partly by the second housing part 86. Before the second housing part 86 is pushed into the recess formed by the circumferential collar 90, the cover 88 is inserted into the second housing part 86 and fixed, being welded or pressed in for example, in order to close the swirl chamber 26 in a liquid-tight manner at its upper end in FIG. 16.

After the two housing parts 84, 86 are in the position shown in FIG. 16, the two housing parts can be fixed to one another and sealed with a circumferential weld seam 90, see also FIG. 14.

FIG. 17 shows a view of the section plane E-E in FIG. 16, although FIG. 16 shows only the position of the section plane E-E, but the section plane E-E does not pass through the sectioned cone nozzle 80 of FIG. 16, instead passing through the entire cone nozzle as illustrated, for example, in FIG. 15.

The view in FIG. 17 shows the liquid inlet 12, which is arranged concentrically with the central longitudinal axis of the cone nozzle 80. The first rectilinear section 38 of the feed channel 36 starts from the liquid inlet 12. In FIG. 17 it is possible to see into the second rectilinear section 40 of the feed channel 36.

The cone nozzle 80 illustrated in FIGS. 14 to 17 is of simple construction and the two housing parts 84, 86 can be aligned correctly with respect to one another without problems by means of the circumferential collar 92 of the first housing part 80 and by means of a locating pin in the recesses 52. The weld seam 90 connects the two housing parts 84, 86 and also seals them. As a result, the cone nozzle 80 can be produced with comparatively little effort.

1. A cone nozzle having a housing, wherein the housing has a liquid inlet, a swirl chamber, a feed channel extending from the liquid inlet and opening into the swirl chamber, and an outlet channel having an outlet opening, wherein the outlet channel starts from the swirl chamber, wherein, directly upstream of the opening into the swirl chamber, the feed channel is aligned tangentially with respect to an imaginary circular line around the central longitudinal axis of the swirl chamber, wherein the liquid inlet is arranged parallel to the central longitudinal axis of the swirl chamber, and the feed channel has at least two deflections through an angle of between 80 degrees and 100 degrees each between the liquid inlet and the opening into the swirl chamber.

2. The cone nozzle according to claim 1, wherein two rectilinear sections of the feed channel meet at at least one of the deflections of the feed channel.

3. The cone nozzle according to claim 1, wherein the feed channel has a cross section which is constant with the exception of the deflections, wherein the cross section in the region of the deflections is greater than or equal to the cross section outside the region of the deflections.

4. The cone nozzle according to claim 1, wherein the feed channel has three rectilinear sections each having a constant cross section, wherein a first rectilinear section is arranged between the liquid inlet and the first deflection, a second rectilinear section is arranged between the first deflection and the second deflection and a third rectilinear section is arranged between the second deflection and the opening of the feed channel into the swirl chamber.

5. The cone nozzle according to claim 1,
wherein the feed channel has a circular cross section with the exception of the deflections.

6. The cone nozzle according to claim 1,
wherein the housing is of at least two-part design, wherein a first housing part has at least one section of the liquid inlet and one part of the feed channel, and a second housing part has the swirl chamber, the outlet channel and a further part of the feed channel.

7. The cone nozzle according to claim 6, wherein the swirl chamber is closed by a cover at its end opposite the outlet channel.

8. The cone nozzle according to claim 7, wherein the cover is formed integrally on the first housing part.

9. The cone nozzle according to claim 6, wherein the first housing part and the second housing part are accommodated, at least partially, in a bore of a third housing part.

10. The cone nozzle according to claim 9, wherein a union nut is provided, which is screwed onto the third housing part and via which the first housing part and the second housing part are preloaded against one another and held in the bore of the third housing part.

11. The cone nozzle according to claim 6,
wherein the first housing part has a circumferential collar, wherein the collar defines a recess in which the second housing part is partially accommodated.
